(19) United States
(12) Patent Application Publication
(10) Pub. No.: US 2026/0338232 A1
(43) Pub. Date: Oct. 29, 2026

(54) SHAFT ARRANGEMENT WITH AT LEAST ONE SHAFT OF A VEHICLE MOUNTED IN A HOUSING

(71) Applicant: ZF Friedrichshafen AG, Friedrichshafen (DE)

(72) Inventor: David Rittler, Neukirch (DE)

(73) Assignee: ZF Friedrichshafen AG, Friedrichshafen (DE)

(21) Appl. No.: 19/388,108

(22) Filed: Nov. 13, 2025

(30) Foreign Application Priority Data
Nov. 14, 2024 (DE) 10 2024 210 921.5

(51) Int. Cl. F16C 33/66; B60K 17/22; F16C 3/02; F16C 33/78

(52) U.S. Cl. CPC F16C 33/6659; B60K 17/22; F16C 3/02; F16C 33/7816

(57) ABSTRACT

A shaft arrangement has at least one shaft (2) of a vehicle mounted in a housing (1), where at least one oil-guiding structure is associated with the shaft (2) such that an annular space (6) extending in the axial direction between the shaft (2) and the oil-guiding structure is provided for guiding the oil. At least one approximately sleeve-shaped seal carrier (7) is arranged coaxially with the shaft (2), where the seal carrier (7) includes at least one approximately radially extending oil supply duct (8), and the oil supply duct (8) is connected to an oil supply on the housing side for supplying oil radially into the annular space (6). In addition, an axle drive (3) with such a shaft arrangement is proposed.

### RELATED APPLICATIONS

This application claims the benefit of and right of priority under 35 U.S.C. § 119 to German Patent Application no. 10 2024 210 921.5, filed on 14 Nov. 2024, the contents of which are incorporated herein by reference in its entirety

### FIELD OF THE DISCLOSURE

The present invention relates to a shaft arrangement with at least one shaft of a vehicle mounted in a housing, wherein at least one oil-guide structure is associated with the shaft so that an annular space extending in the axial direction is provided between the shaft and the oil-guide structure for guiding the oil. In addition, the invention relates to an axle drive of a vehicle with a shaft arrangement.

### BACKGROUND

For example, DE 10 2018 108 670 A1 describes a shaft arrangement with a solid shaft and a hollow shaft, wherein the solid shaft and the hollow shaft are arranged coaxially with one another and wherein the hollow shaft surrounds the solid shaft radially. Between the solid shaft and the hollow shaft is arranged a sleeve section so that an annular space is formed radially between the solid shaft and the hollow shaft, such that the inside diameter of the sleeve section has an oil-supply structure so that oil introduced on the axial side passes along the oil-supply structure in the axial direction through the annular space until the oil emerges through radial holes in the sleeve section and the hollow shaft.

### SUMMARY

Since owing to torque loading, the shafts are severely endangered by stresses, and it is unconditionally necessary to avoid holes in the axial direction and also in the radial direction, as the stresses concentrate in such areas.

The purpose of the present invention is to propose a shaft arrangement of a vehicle and an axle drive with the shaft arrangement, which enable oil to be supplied and distributed axially without providing stress-endangered geometrical features in the shaft.

According to the invention, this objective is achieved by the features specified in a shaft arrangement and in a vehicle axle drive as disclosed herein. Advantageous and claimed further developments emerge from the description and the drawings.

Thus, a shaft arrangement with at least one shaft of a vehicle mounted in a housing is proposed, wherein at least one oil-guiding structure is associated with the shaft so that an annular space or the like extends in the axial direction between the shaft and the oil-guiding structure for guiding or distributing the oil. In order to realize radial and axial oil guiding in the shaft arrangement without producing stress-endangered geometrical features, it is provided that at least one sleeve-shaped seal carrier or the like is arranged coaxially with the shaft, wherein the seal carrier has at least one approximately radially extending oil supply duct or the like, and wherein the oil supply duct is connected with an oil supply on the housing side for guiding oil radially into the annular space.

In this way, a shaft arrangement with a seal carrier is proposed, wherein an axial supply or distribution of oil are both enabled without stress-endangered geometrical features in a shaft or a central shaft of a transmission. By virtue of the simple design of the seal carrier, for example made of plastic or similar material, a particularly inexpensive shaft arrangement can be produced. The seal carrier can for example be produced by injection molding.

In order to minimize the assembly costs and also the production costs for the proposed shaft arrangement, it is provided that the seal carrier can be fixed detachably onto the housing by an interlocking connection or by a friction-force connection.

A particularly simply designed connecting possibility is realized by arranging as connectors a plurality of detent tabs or the like distributed around the circumference of the seal carrier, each of which engages in a recess in the housing. In that way, for assembly the seal carrier can be simply clipped onto the housing.

With the proposed shaft arrangement, it is possible without problems to enable oil to be supplied centrally, for example in the area of a transmission, a drive unit, or other components in the housing, since as viewed axially the seal carrier is arranged between the bearings of the shaft in the housing. Thereby stress-endangered geometries in the shaft can be avoided, which with a lateral oil supply through the shaft as viewed axially, are unconditionally necessary.

To enable simply designed and easily assembled and inexpensive sealing of the seal carrier, on the inside diameter of the seal carrier at least two grooves extending at a predetermined axial distance relative to one another can be provided for fitting in or injection-molding seals, the axial distance being chosen in such manner that the oil supply duct of the seal carrier is arranged between the two seals. In that way, a seal is formed in the area pf the oil transfer between the seal carrier and the annular space.

Particularly advantageously, with the proposed shaft arrangement it is additionally possible to carry out a secondary lubrication of bearings, in particular of the shaft, in that at least one of the seals or sealing rings or the like fitted into the groove is designed such that a predetermined leakage oil flow is produced for supplying oil at least to the bearing of the shaft facing toward the seal carrier. In that way, in the area of the oil transfer between the seal carrier and the annular space oil is deliberately passed in the axial direction through the seal in order to supply the immediately adjacent shaft bearing with oil.

The oil-guiding structure as designed can be produced in various ways. A particularly simple and inexpensive possible design can be produced if, as the oil-guiding structure, by providing at least one first sleeve arranged coaxially with the shaft for forming the annular space, and a second sleeve arranged coaxially with the shaft and associated with an axial end of the first sleeve, wherein the second sleeve is fixed at a first axial end to the first sleeve and at a second axial end to the shaft, and wherein the second sleeve has a radially extending through-flow opening to allow flow into the annular space. In that way, the first sleeve, for example the longer one as viewed axially, can realize the axially directed oil distribution whereas the second sleeve, substantially shorter as viewed axially, corresponds exactly to the oil transfer interface between the annular space and the seal carrier, since the through-flow opening in the second sleeve can be precisely associated with the oil-guiding duct of the seal carrier. Thus, the oil-guiding duct of the seal carrier can be connected to the through-flow opening of the second sleeve in order to guide oil from an oil-supply tube of the oil supply arrangement in the housing into the annular space in the most simple manner. The oil-supply tube can be accommodated at least in part in the oil-guiding duct of the seal carrier.

In order also to produce as assembly-friendly a seal as possible of the oil-guiding duct of the seal carrier in the proposed shaft arrangement, on the inside diameter of the oil-guiding duct of the seal carrier at least one all-round groove for fitting in a seal or sealing ring or suchlike can be provided, wherein the all-round seal is in contact with an outer diameter of the oil-supply tube of the oil supply arrangement in the housing.

The stated objective of the invention is also achieved by an axle drive of a vehicle, preferably a utility vehicle or the like, having at least one shaft arrangement as described above. This secures the already described advantages and others besides.

The axle drive claimed can for example comprise at least one drive unit, preferably an electric machine or the like, which for example is connected via transmission gearing and a drive output differential for driving drive output shafts of the vehicle. The proposed shaft arrangement in the housing can for example constitute one of the drive output shafts. The proposed shaft arrangement then enables the drive unit and the transmission to be supplied with oil in the housing without the need for stress-endangered geometries or holes in the drive output shaft. However, it is also conceivable that other shafts too are made with the shaft arrangement.

### BRIEF DESCRIPTION OF THE DRAWINGS

Below, the present invention is explained more fully with reference to the drawings, which show:

FIG. 1: A schematic sectioned view of a possible embodiment variant of a shaft arrangement according to the invention in an axle drive of a vehicle according to the invention;

FIG. 2: A schematic sectioned view as in FIG. 1, in a different section plane;

FIG. 3: An individual-part view of a seal carrier of the shaft arrangement according to the invention;

FIG. 4: A detailed schematic sectioned view of the shaft arrangement with detent tabs provided for fixing to the housing; and

FIG. 5: A detailed schematic sectioned view of the shaft arrangement with a seal that allows a leakage flow for the supply of oil to a bearing of a shaft of the shaft arrangement.

### DETAILED DESCRIPTION

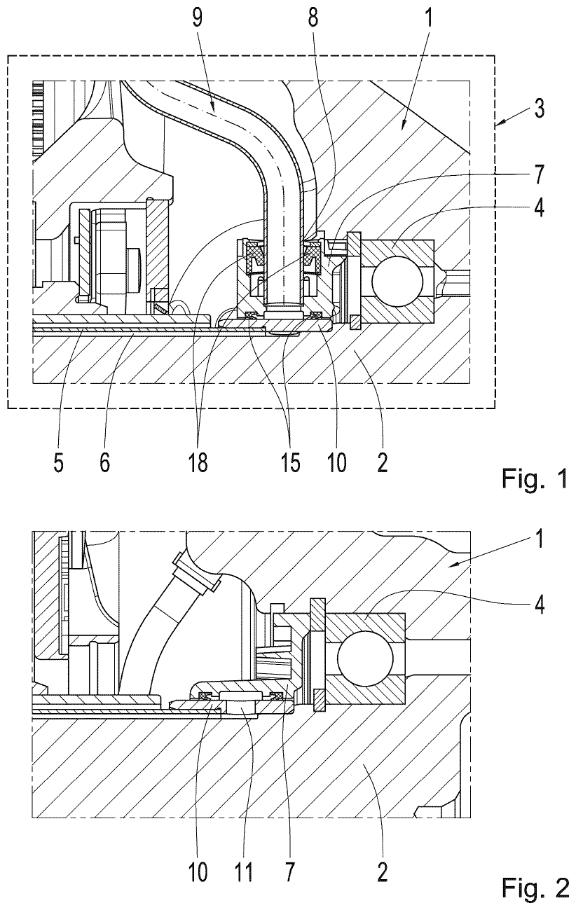

FIGS. 1 to 5 show as an example various views and representations of a shaft arrangement according to the invention, in an axle drive 3 according to the invention, and in a vehicle, in particular a utility vehicle. The axle drive 3 comprises at least one drive unit in a housing 1, for example an electric machine, which by way of transmission gearing and a drive output differential drives two drive output shafts for driving the wheels of the vehicle; in FIG. 1 the axle drive 3 is shown only schematically.

The proposed shaft arrangement comprises at least one shaft 2 mounted in the housing 1. As the shaft 2, various shafts can be provided, for example such as central shafts in a transmission or the like. The shaft 2 shown as an example in the figures is one of the drive output shafts of the axle drive 3 of a utility vehicle, which shaft is mounted in the housing 1 by means of two bearings, of which only one bearing 4 is shown in FIGS. 1 and 2.

As can be seen for example in FIGS. 1 and 2, associated with the shaft 2 of the proposed shaft arrangement there is an oil-guiding structure, such that an annular space 6 which extends in the axial direction for guiding the oil is provided between the shaft 2 and the oil-guiding structure in the form of a first sleeve 5.

To achieve radial oil guiding and at the same time axial oil guiding or oil distribution in a simply designed and inexpensive manner, at least one approximately sleeve-shaped seal carrier 7 arranged coaxially with the shaft 2 is provided, wherein the seal carrier 7 comprises at least one approximately radially extending oil-guiding duct 8 and wherein, to enable oil to pass radially into the annular space 6, the oil-guiding duct 8 is connected to an oil supply tube 9 of an oil supply on the housing side.

The first sleeve 5 of the oil-guiding structure is arranged coaxially with the shaft 2 and partially encloses it, so that as viewed radially the axially extending annular space 6 for guiding or distributing the oil axially is formed between the first sleeve 5 and the shaft 2. In addition, a second sleeve 10 is provided, which is arranged coaxially with the first sleeve 5 and the shaft 2, wherein the second sleeve 10 is attached at a first axial end to the first sleeve 5 and at a second axial end to the shaft 2. In that way, by virtue of the second sleeve 10 an axial gap between the end of the first sleeve 5 and a step on the second shaft 2 is sealed, since in the area of the shaft step the second sleeve 10 partially surrounds both the first sleeve 5 and the shaft 2 radially on the outside. The second sleeve 10 has a radially extending through-flow opening 11, so that a flow connection is formed between the oil supply tube 9 of the oil supply in the housing located in the oil-supply duct 8 and the annular space 6, via the through-flow opening 11 of the second sleeve 10, as can be seen clearly in FIGS. 1 and 2.

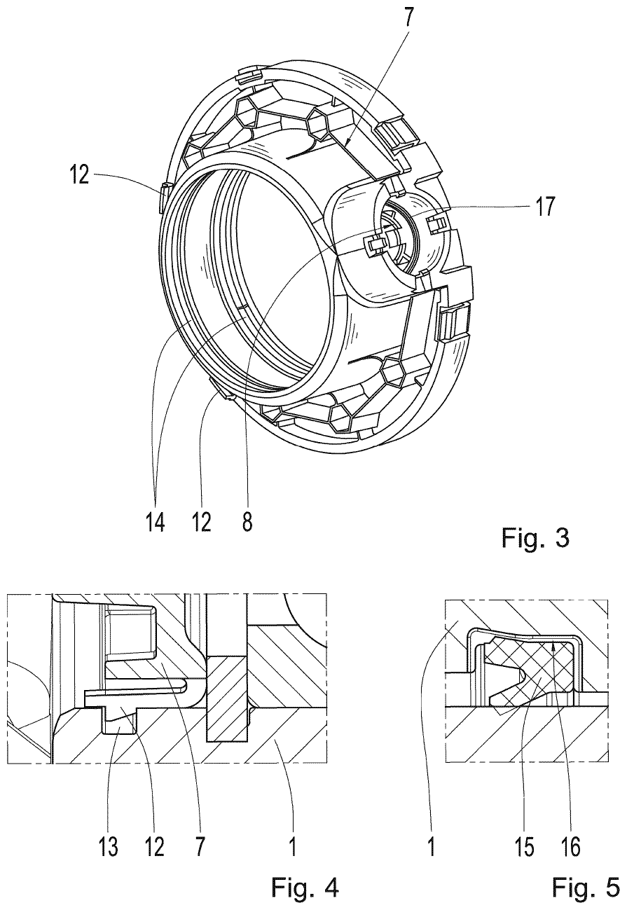

FIG. 3 shows a detailed individual-part view of the sleeve-shaped seal carrier 7 with the radially orientated oil-supply duct 8 in the circumferential area of the seal carrier 7. In the oil-supply duct 8 the oil-supply tube 9 of the oil supply in the housing is fixed in the annular space 6 as shown in FIG. 1. To fix the seal carrier 7 detachably onto the housing, a plurality of detent tabs 12 are arranged distributed around the outer circumference of the seal carrier 7, each of which engages in an associated recess 13 in the housing as shown in FIG. 4.

Furthermore, from FIG. 3 it can be seen that on the inside diameter of the seal carrier 7, at a predetermined axial distance from one another all-round grooves or depressions 14 are provided for fitting or injection-molding seals or sealing rings 16. The axial distance between the grooves 14 is chosen such that the oil-guiding duct 8 of the seal carrier 7 is sealed by the two scaling rings 15, as shown in FIGS. 1 and 2.

The sealing ring 15 shown on the right in the figure plane of FIGS. 1 and 2 is shown in detail in FIG. 5, wherein from the detailed representation it is made clear that the sealing ring fitted into the groove 14 is designed such that a predetermined leakage flow 16 for supplying oil to the bearing 4 of the shaft 2 facing toward the seal carrier 7 is made possible. In that way, as it were, a secondary oil supply for the bearing 4 is enabled by the proposed shaft arrangement.

From the individual-part view shown in FIG. 3 it is clear that on the inside diameter of the oil-guiding duct 8 of the seal carrier 7 an all-round groove 17 for fitting or injection-molding a sealing ring 18 is provided, wherein the all-round sealing ring 18 makes contact with an outer diameter of the oil supply tube 9 of the oil supply system of the housing, as shown in FIG. 1.

### INDEXES

1 Housing
2 Central shaft or drive output shaft of an axle drive
3 Axle drive
4 Bearing of the shaft
5 First sleeve as an oil-guide structure
6 Annular space
7 Seal carrier
8 Oil supply duct of the seal carrier
9 Oil supply tube of the oil supply on the housing side
10 Second sleeve as an oil-guide structure
11 Through-flow opening of the second sleeve
12 Detent tabs
13 Recesses in the housing for the detent tabs
14 All-round groove
15 Seal or sealing ring
16 Leakage flow
17 All-round groove in the oil supply duct
18 Seal or sealing ring in the oil supply duct

1. A shaft arrangement with at least one shaft (2) of a vehicle mounted in a housing (1), comprising:
at least one oil-guiding structure associated with the shaft (2) so that an annular space (6) extending in the axial direction is provided between the shaft (2) and the oil-guiding structure for guiding oil, and
at least one approximately sleeve-shaped seal carrier (7) arranged coaxially with the shaft (2), wherein the seal carrier (7) has at least one radially extending oil supply duct (8) connected to an oil supply on a housing side for supplying oil radially into the annular space (6).

2. The shaft arrangement according to claim 1, wherein the seal carrier (7) is configured to be attached by an interlocking or friction-force connection to the housing (1) in a detachable manner.

3. The shaft arrangement according to claim 2, comprising a plurality of detent tabs (12) configured for connecting the seal carrier to the housing. the detent tabs (12) distributed around an outer circumference of the seal carrier (7) and engaging in associated recesses (13) in the housing.

4. The shaft arrangement according to claim 1, wherein as viewed axially, the seal carrier (7) is arranged between bearings of the shaft (2).

5. The shaft arrangement according to claim 1, wherein an inside diameter of the seal carrier (7) defines at least two all-round grooves (14) spaced by a predetermined axial distance and configured for fitting seals (15) or injection-molding seals (15), wherein the axial distance is chosen such that the oil supply duct (8) of the seal carrier (7) is arranged between the two seals (15).

6. The shaft arrangement according to claim 5, wherein at least one of the seals (15) provided in the at least two all-round grooves (14) is configured such that a predetermined leakage flow (16) is enabled for supplying oil at least to an adjacent bearing (4) of the shaft (2).

7. The shaft arrangement according to claim 1, wherein the oil-guiding structure comprises:
at least one first sleeve (5) arranged coaxially with the shaft (2) and configured for forming the annular space (6); and
a second sleeve (10) associated with an axial end of each at least one first sleeve (5), wherein the second sleeve (10) is attached at a first axial end to each at least one first sleeve (5) and at a second axial end to the shaft (2), and wherein the second sleeve (10) has a through-flow opening (11) which extends radially and is in flow-enabling connection with the annular space (6).

8. The shaft arrangement according to claim 7, wherein the oil supply duct (8) of the seal carrier (7) is in flow-enabling connection with the through-flow opening (11) of the second sleeve.

9. The shaft arrangement according to claim 1, an inside diameter of the oil supply duct (8) of the seal carrier (7) defines at least one all-round groove (17) for fitting or injection-molding all-round seal (18), wherein the all-round seal (18) makes contact with an outer diameter of an oil supply tube (9) of the oil supply system of the housing provided in the oil supply duct (8).

10. An axle drive (3) of a vehicle with at least one shaft arrangement according to claim 1.
